(19) United States
(12) Patent Application Publication
(10) Pub. No.: US 2007/0266379 A1
(43) Pub. Date: Nov. 15, 2007

(54) Compile method, debug method, compile program and debug program

(76) Inventor: Shinobu Asao, Osaka (JP)

Correspondence Address: MCDERMOTT WILL & EMERY LLP, 600 13TH STREET, NW, WASHINGTON, DC, 20005-3096, US

(21) Appl. No.: 11/797,797

(22) Filed: May 8, 2007

(30) Foreign Application Priority Data
May 11, 2006 (JP) 2006-132380

(51) Int. Cl. G06F 9/45

(52) U.S. Cl. 717/140

(57) ABSTRACT

Language specification in each of at least two particular ranges set in an inputted program are decided in a partial language specification deciding step. It is judged if there is a difference between the language specifications in the particular ranges is judged in a judging step. At least a part of codes in one of the particular ranges is corrected when it is judged that there is the difference between the language specifications in the particular ranges in a partial code correcting step.

### BACKGROUND OF THE INVENTION

1. Field of the Invention

The present invention relates to a compile method, a debug method, a compile program and a debug program for converting a program described in a high-level language into an object program.

2. Description of the Related Art

In software development in recent years, a program scale has been increasing, and an object-oriented language having a high maintainability and a high reusability has been watched based on such situations. A typical example of the object-oriented language is the C++ language. The C++ language is becoming the focus of attention as a language that replaces the C language conventionally widely used for programming over the years, and the language in the programming shifts from the C language to the C++ language across the relevant technical field. In the language shift, an object code operated without any problem can be generated only through simply replacing a C language compiler with a C++ language compiler under normal conditions because the C++ language is a high-order compatible language of the C language. However, when a program recited in the C language is compiled in the C++ language, there causes a problem that a code size and an execution time are unfavorably increased.

A conventional first solution for the problem is to use a linkage assignment with respect to a program as recited in the Literature (see “The linkage assignment in Chapter 7.4, “The Annotated C++ Reference Manual” written by M. A. Ellis, B. Stroustrup, translated by Takanori Adachi and Hiroshi Koyama) A second solution is to analyze a range of language specification in a program and automatically apply the language specification of a subset for the compilation as far as possible as recited in No. 2003-50700 of the Japanese Patent Applications Laid-Open.

In the first solution, however, a programmer is forced to take the linkage assignment into account in the programming, which stand the way of easily shifting from the C language to the C++ language. In the second solution, a consistency is not taken account with respect to encoding symbols in the program (function name, variable name and the like) though compilation from the C++ language to the EC++ language that is the C++ subset specification for built-in use is possible. As a result, it becomes impossible to expect optimization such as the through reduction of the code size and the execution time based on the degeneracy of the language specification.

### SUMMARY OF THE INVENTION

Therefore, a main object of the present invention is to provide a compile method wherein a program can be easily shifted by a programmer to an upward compatible program without being aware of any linkage assignment, and reduction of a code size and an execution time can be realized as a result of maximal degeneracy of a language specification, and a debug method capable of tuning easily.

In order to solve the foregoing problem, a compile method according to the present invention is a compile method for converting an inputted program into an object program, including:

a partial language specification deciding step for deciding language specification in at least two particular ranges set in the inputted program;

a judging step for judging if there is a difference between the language specifications in the particular ranges; and

a partial code correcting step for correcting at least a part of codes in one of the particular ranges when it is judged that there is the difference between the language specifications in the particular ranges.

According to the foregoing method, since the codes are corrected so that they can be combined with each other, programs including the partially different language specification can be combined and compiled in an optimum language specification, the codes can be generated more efficiently.

Preferably, the language specifications are decided based on facility of a programming language used in the particular ranges in the partial language specification deciding step.

According to the foregoing method, since the programmer can combine programs including the partially different language specifications without correcting a source program, and the programs can be compiled in an optimum language specification, the codes can be generated more efficiently.

As a more preferable mode of the foregoing method, the language specifications are decided based on a language specification control statement in the case where the language specification control statement is present in the inputted program in the partial language specification deciding step.

According to the foregoing method, for example, the programmer describes the language specification control statement according to a #pragma instruction in the source program, and thereby the language specification can be freely selected without any influence from facilities originally described in the source program.

More preferably, in the language specification deciding step, the language specifications are decided based on a language specification control instruction in the case where the language specification control instruction is given to a compile system for compiling the inputted program.

According to the foregoing method, for example, the programmer provides the language specification control instruction based on an option of the compile system, and thereby the language specification can be freely selected without correcting the source program and without any influence from the facilities originally described in the source program.

More preferably in the partial code correcting step, a function coding name having a language specification of a subset is changed into a function coding name having a language specification of a superset in the case where there is a difference between the language specifications in definition and reference in all of functions.

According to the foregoing method, the programs can be combined even when there is any difference between the language specifications of the definition and the reference.

As a more preferable mode of the foregoing method, in the partial code correcting step, when all of external functions that are multiple-defined are changed into an external function which has a singular function name and is not multiple-defined in the program, and the all of external functions that are multiple-defined are changed into the external function that has the singular function name and is not multiple-defined in the program, the partial language specification deciding step is executed again.

According to the foregoing method, the C++ program that uses the multiple-defined functions can be compiled as the C program, which improves the efficiency in the code generation.

As a more preferable mode of the foregoing method, in the partial code correcting step, when all of external functions which belong to a namespace, are changed into an external function that has a singular function name and does not belong to the namespace in the program, and the all of external functions which belong to the namespace are changed into the external function that has the singular function name and does not belong to the namespace in the program, the partial language specification deciding step is executed again.

According to the foregoing method, the C++ program using the namespace can be compiled as the C program, which improves the efficiency in the code generation.

As a more preferable mode of the foregoing method, in the partial code correcting step, when all of external functions that are generated from a template are changed into an external function that has a singular function name and is not generated from the template in the program, and the all of external functions that are generated from the template are changed into the external function that has the singular function name and is not generated from the template in the program, the partial language specification deciding step is executed again.

According to the foregoing method, the C++ program using the namespace can be compiled as the C program, which improves the efficiency in the code generation.

A debug method according to the present invention is a debug method for debugging an inputted program, including:

a partial language specification acknowledging step for acknowledging language specifications in each of at least two particular ranges set in the inputted program; and

a partial language specification displaying step for displaying the acknowledged language specifications in each of the particular ranges together with program source thereof.

According to the foregoing method, the programmer can easily confirm which part of the program is compiled through which of the language specifications. As a result, the debugging and tuning operations can be efficiently performed.

As a preferable mode of the foregoing method, the method further includes a template development displaying step for displaying a source program in which the template is developed in the case where an object to be analyzed is an instance generated from the template.

According to the foregoing method, the programmer can easily grasp the source program after the template is developed, and the debugging and tuning operations can be efficiently performed.

As a more preferable mode of the foregoing method, the method further includes a displaying step of a subset language specification violation part for explicitly showing contents of a part of the program deviating from a language specification of a subset in the case where the language specification of the subset is defined in the acknowledged language specification.

According to the foregoing method, the programmer can easily grasp the part of the program deviating from the subset, and the tuning operation can be more efficiently performed.

The present invention not only can realize the compile method and the debug method including these characteristic steps but also can realize a compile program and a debug program that make a computer execute these characteristic steps included in the compile method and the debug method, and a compile device and a debugger device which execute these characteristic steps included in the compile method and the debug method. Further, it is needless to say that the compiler and the debugger can be distributed via a recording medium such as CD-ROM (compact disc read-only memory) and a transmission medium such as Internet.

A compile program according to the present invention is a compile program for converting an inputted program into an object program, the compile program making a computer execute:

a partial language specification deciding facility for deciding language specification in each of at least two particular ranges set in the inputted program;

a facility for judging if there is a difference in the language specifications between the particular ranges; and

a partial code correcting facility for correcting at least a part of codes in one of the particular ranges in the case where it is judged there is the difference in the language specifications between the particular ranges.

As a preferable mode of the foregoing program, the partial language specification deciding facility decides the language specification based on facility of a programming language used in the particular ranges.

As a more preferable mode of the foregoing program, the partial language specification deciding facility decides the language specification based on a language specification control statement in the case where there is the language specification control statement in the inputted program.

As a more preferable mode of the foregoing program, the partial language specification deciding facility decides the language specifications based on a language specification control instruction in the case where the language specification control instruction is provided to a compile system for compiling the inputted program.

As a more preferable mode of the foregoing program, the partial code correcting facility changes a function-coding name having a language specification of a subset into a function-coding name having a language specification of a superset in the case where there is a difference between the language specifications of definition and reference in all of functions.

As a more preferable mode of the foregoing program, the partial code correcting facility changes all of external functions which are multiple-defined into an external function which has a singular function name and is not multiple-defined in the program, and the partial language specification deciding facility is executed again when the all of external functions which are multiple-defined are changed into the external function which has the singular function name and is not multiple-defined in the program.

As a more preferable mode of the foregoing program, the partial code correcting facility changes all of external functions that belong to a name space into an external function which has a singular function name and does not belong to the name space in the program, and the partial language specification deciding function is executed again when the all of external functions which belong to the name space are changed into the external function which has the function name and does not belong to the name space in the program.

As a more preferable mode of the foregoing program, the partial code correcting facility changes all of external functions that are generated from a template into an external function which has a singular function name in the program and is not generated from the template, and the partial language specification deciding step is executed again when the all of external functions that are generated from the template are changed into the external function that has the singular function name in the program and is not generated from the template.

A debug program according to the present invention is a debug program for debugging an inputted program and for making a computer execute the following facilities:

a partial language specification acknowledging facility for acknowledging language specifications in each of at least two particular ranges where the inputted program is set; and

a partial language specification displaying facility for displaying the acknowledged language specifications in each of the particular ranges together with program source thereof.

As a preferable mode of the foregoing program, it is the debug program for further making the computer execute a template development displaying facility for displaying a source program in which the template is developed in the case where an object for analysis is an instance generated from the template.

As a more preferable mode of the foregoing program, it is the debug program for further making the computer execute a subset language specification violation displaying step for explicitly showing contents of a part of the program deviating from a language specification of a subset in the case where the language specification of the subset is defined in the acknowledged language specification.

According to the compile method of the present invention, the programs including the partially different language specifications can be combined easily and compiled in an optimum language specification. As a result, the codes can be more efficiently generated. Further, according to the debug method of the present invention, the programmer can easily grasp by which of the language specifications the part of the program is compiled and which part of the source program should be corrected when it is changed into the language specification of the subset. As a result, the debugging and tuning operations can be efficiently executed.

The compile method and the debug method according to the present invention can be effectively applied to a compile method, a debug method and the like for an embedded device which demands an object code having a small code size such as a mobile telephone and PDA (personal digital assistant).

### BRIEF DESCRIPTION OF THE DRAWINGS

These and other objects as well as advantages of the invention will become clear by the following description of preferred embodiments of the invention. A number of benefits not recited in this specification will come to the attention of those skilled in the art upon the implementation of the present invention.

FIG. 1 is a flow chart of processing steps executed by a compiler according to a preferred embodiment of the present invention.

FIG. 2 is a flow chart showing details of a partial language specification deciding step.

FIG. 3 is a flow chart showing details of a partial code correcting step.

FIG. 4 is a flow chart of processing steps executed by a debugger according to the preferred embodiment.

FIG. 5 is a flow chart showing details of a partial language specification displaying step.

FIG. 6 shows an example of a source program memorized in a program memorizing unit used in a specific example 1.

FIG. 7 shows an example of intermediate code information according to the prior art.

FIG. 8 shows an example of a source program corrected by a conventional method.

FIG. 9 shows an example of intermediate code information after the source program used in the specific example 1 is applied to the partial language specification deciding step.

FIG. 10 shows an example of intermediate code information after the source program used in the specific example 1 is applied to the partial language code correcting step step.

FIG. 11 shows an example of a source program memorized in a program memorizing unit used in a specific example 2.

FIG. 12 shows an assembly code in which the source program used in the specific example 2 is compiled with the C++ language and an assembly code in which the source program used in the specific example 2 is compiled with the C language.

FIG. 13 shows an example of the intermediate code information after the source program used in the specific example 2 is applied to a first partial language specification deciding step.

FIG. 14 shows an example of the intermediate code information after the source program used in the specific example 2 is applied to a first partial code correcting step.

FIG. 15 shows an example of the intermediate code information after the source program used in the specific example 2 is applied to a second partial language specification deciding step.

FIG. 16 shows an assembly code in which the method according to the present invention is not applied to the source program used in the specific example 2 and an assembly code in which the relevant method is applied thereto.

FIG. 17 shows a debugger monitor that displays a source program used in a specific example 3.

FIG. 18 shows a debugger monitor that displays language specification information of the source program used in the specific example 3.

FIG. 19 shows a debugger monitor that displays a source program in which a template of the source program used in the specific example 3 is developed.

FIG. 20 shows a debugger monitor that displays contents of a part of the program deviating from a C-language specification in the source program used in the specific example 3.

FIG. 21 is a flow chart of a conventional program converting method (second solution).

### DETAILED DESCRIPTION OF THE INVENTION

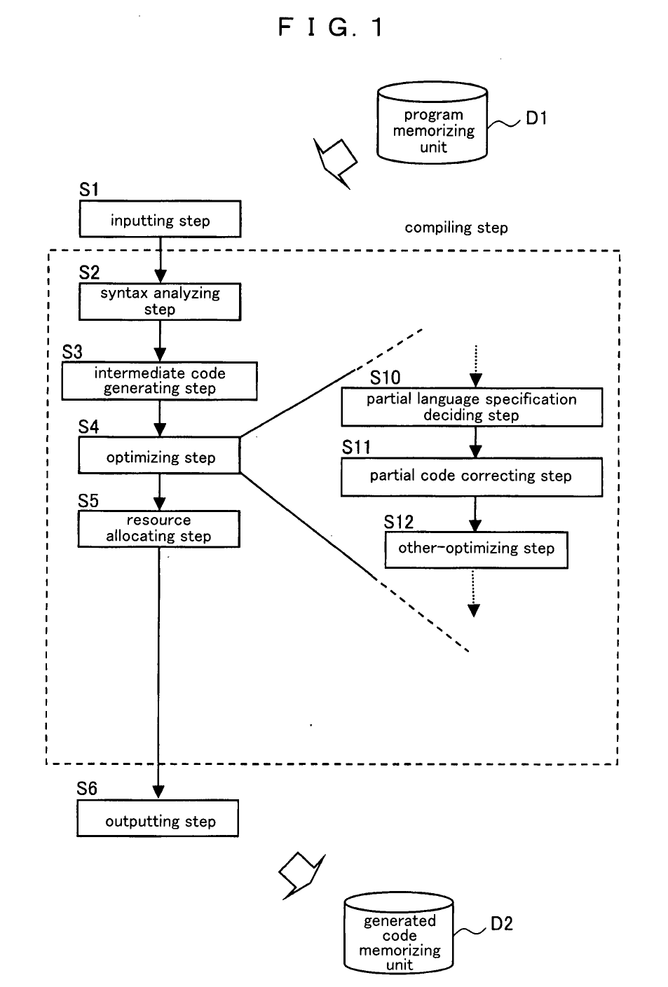

Hereinafter, a compile method according to a preferred embodiment of the present invention is described referring to the drawings. FIG. 1 is a flow chart of processing steps executed by a compiler.

The compiler reads a header file and a source program memorized in a program memorizing unit D1 (Step S1). The compiler analyzes the syntax of the read source program, and generates a symbol table and a syntax tree (Step S2). Next, the compiler generates an intermediate code based on the generated syntax tree (Step S3). After that, the compiler executes various optimizing processes to the generated intermediate code (Step S4). Further, the compiler allocates hardware resources such as a register and a memory to all of variables included in the optimized intermediate code (Step S5), and then, converts the resource-allocated intermediate code into an object code and outputs an object program thereof to a generated code memorizing unit D2 (Step S6).

The optimizing step S4 includes a partial language specification deciding step S10, a partial code correcting step S11, and else optimizing step S12. In the partial language specification deciding step S10, the intermediate code is analyzed, and the language specification in a partial range of each program is decided. In the partial code correcting step S11, the language specification in the partial range of each program that was decided in the partial language specification deciding step S10 is analyzed, and the codes in the respective ranges are corrected so that they can be combined depending on differences in the language specifications in the respective ranges. The details of the partial language specification deciding step S10 and the partial code correcting step S11 will be described later. The else optimizing step S12 is not described since it is a conventional optimizing step and not a subject matter of the present invention.

The source program inputting step S1, the syntax analyzing step S2, the intermediate code generating step S3, the else optimizing step S12, the resource allocating step S5 and the object outputting step S6 are not described in detail because they are similar to the conventional steps and not the main subject matters of the present invention.

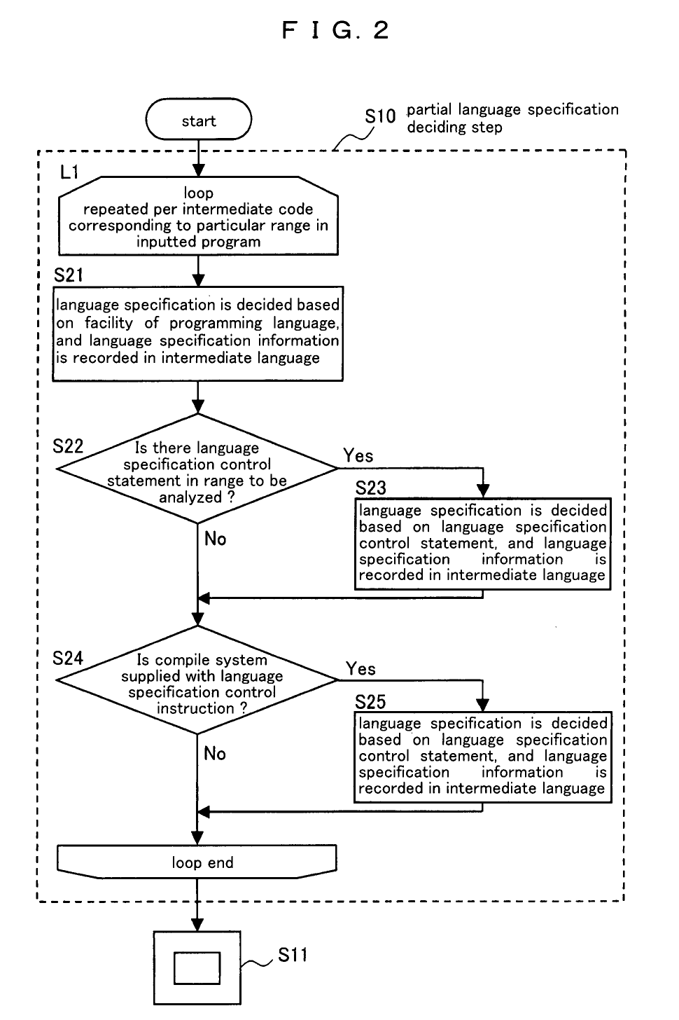

A description is given below of the partial language specification deciding step S10 and the partial code correcting step S11, that are the subject matters of the present invention. FIG. 2 is a flow chart showing details of the partial language specification deciding step S10. As a loop processing L1, steps S21-25 are executed with respect to each of intermediate codes corresponding to at least two particular ranges set in an inputted program. The processing advances to the Step S21 in the case where there is an object for analysis, while the processing advances to the Step S11 in the absence of the object for analysis. In the Step S21, the language specification is decided based on facility of a programming language used in the range of the object for analysis, language specification information is recorded in an intermediate language, and the processing advances to the Step S22. Here, the language specification information is information capable of judging at least with which of the language specifications it complies (for example, such a character string as “C++” when it comes to the C++ language).

In the Step S22, it is judged whether or not there is a language specification control statement in the ranges of the object for analysis. The language specification control statement recited here, is the one where a particular operation is designated to the compiler by describing in the source program so that, for example, as a #pragma instruction. The processing advances to the step S23 when a result of the judgment is true, while advancing to the Step S24 when the result is not true.

In the Step S23, the language specification are decided based on a language specification control instruction, the language specification information is recorded in the intermediate language, and then, the processing advances to the Step S24. In the Step S24, it is judged if the language specification control instruction is provided to a compile system. The language specification control instruction recited here is the one that it is directly given to the compile system so that a particular operation is designated to the compiler as a command line option. The processing advances to the Step S25 when a result of the judgment is true, while advancing to the loop processing L1 when the result is not true.

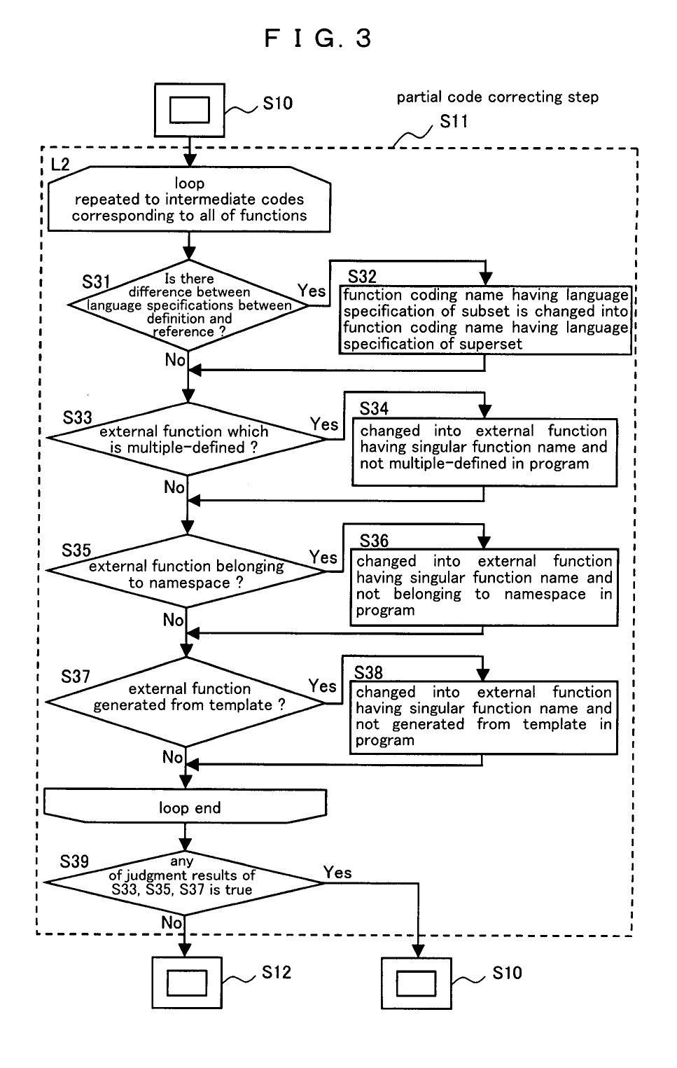

FIG. 3 is a flow chart showing details of the partial code correcting step S11. In a loop processing L2, Steps S31-S38 are executed by each of the intermediate codes of all of functions. The processing advances to the Step S31 in the presence of the object for analysis, while advancing to the Step S39 in the absence of the object for analysis.

In the Step S31, it is judged if there is a difference between the language specifications in a definition and a reference of the relevant function. The difference between the language specifications denotes such a case that the language specification in the definition of the function is recorded “C++” in the intermediate code, and the language specification in the reference of the function is recorded “C” in the intermediate code. The processing advances to the Step S32 when a result of the judgment is true, while advancing to the Step S33 when the result is not true.

In the Step S33, a function coding name having the language specification of a subset is changed into a function coding name having the language specification of a superset, and the processing advances to the Step S33.

In the Step S33, it is judged if the relevant function is an external function that is multiple-defined. The multiple definition denote such a case that functions are defined so that function names thereof are identical and arguments thereof are different as in f(void) and f(int). The processing advances to the Step S34 when a result of the judgment is true, while advancing to the Step S35 when the result is not true.

In the Step S34, the relevant function is changed into an external function that has a singular function name and is not multiple-defined in the program. Then, the processing advances to the Step S35. In the Step S35, it is judged if the relevant function is an external function belonging to a name space. The external function belonging to the name space is a function declared in the scope of the namespace as namespace S{int f(void)}. The processing advances to the Step S36 when a result of the judgment is true, while advancing to the Step S37 when the result is not true.

In the Step S36, the relevant function is changed into an external function that has a singular function name and does not belong to the name space in the program. Then, the processing advances to the Step S37. In the Step S37, it is judged if the relevant function is an external function generated from a template. The external function generated from the template here is a function that is instantiated from a function template defined as in template <class T> Tf(T a). The processing advances to the Step S38 when a result of the judgment is true, while advancing to the loop processing L2 when the result is not true.

In the Step S38, the relevant function is changed into a external function that has a singular function name and is not generated from the template in the program. Then, the processing advances to the L2. In the Step S39, it is judged if any of the judgment results of the Steps S33, S35 and S37 is true. The processing advances to the Step S10 when the judgment result is true, while advancing to the Step S12 when the result is not true.

As described above, the optimizing step S4 including the partial language specification deciding step S10 and the partial code correcting step S11 is executed to the intermediate code, and thereafter the resource allocating step (Step S5) and the object program outputting step (Step S6) are executed to the optimized intermediate code. Thereby, a programmer can shift the program easily to an upward compatible program without being aware of any linkage assignment, and a code size and an execution time can be reduced as a result of the degeneracy of the language specification at a maximum level.

The present invention is not limited to the analysis of the intermediate code, and any type of data can be analyzed as far as it is data representing the syntax analyzing result of the source program.

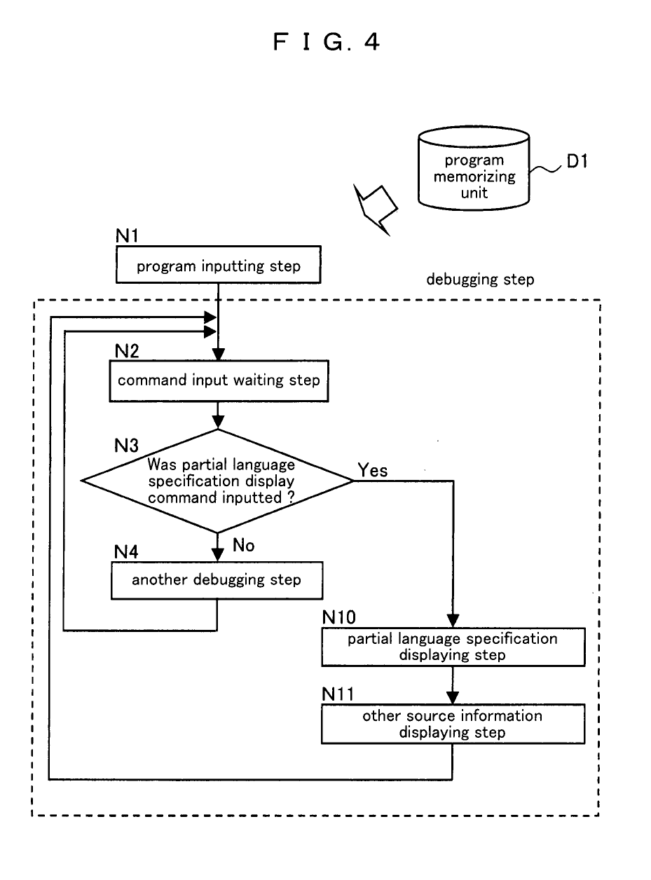

Next, a debug method according to the present preferred embodiment is described referring to the drawings. FIG. 4 is a flow chart of processing steps executed by a debugger. The debugger reads a program memorized in the program memorizing unit D1 (Step N1). The debugger analyzes the read program, and thereafter shifts to the command input waiting Step N2. Next, the debugger judges if a partial language specification display command is inputted (Step N3). When a result of the judgment is true, Step N10 for partially displaying the language specification is executed. After that, Step N11 for displaying other source information is executed, and the processing advances to the command input waiting step N2. When the result is not true, another debugging step (Step N4) is executed, and the processing advances to the command input waiting step N2. The details of the partial language specification displaying step N10 will be described in detail later. Since the other source displaying Step N11 is a step for displaying a general source information, and is not a subject matter of the present invention, it is not described.

In addition, the program inputting step N1, the command input waiting step N2, and the another debugging step N4 are not described in detail because they are processing steps similar to the conventional steps and are not subject matters of the present invention.

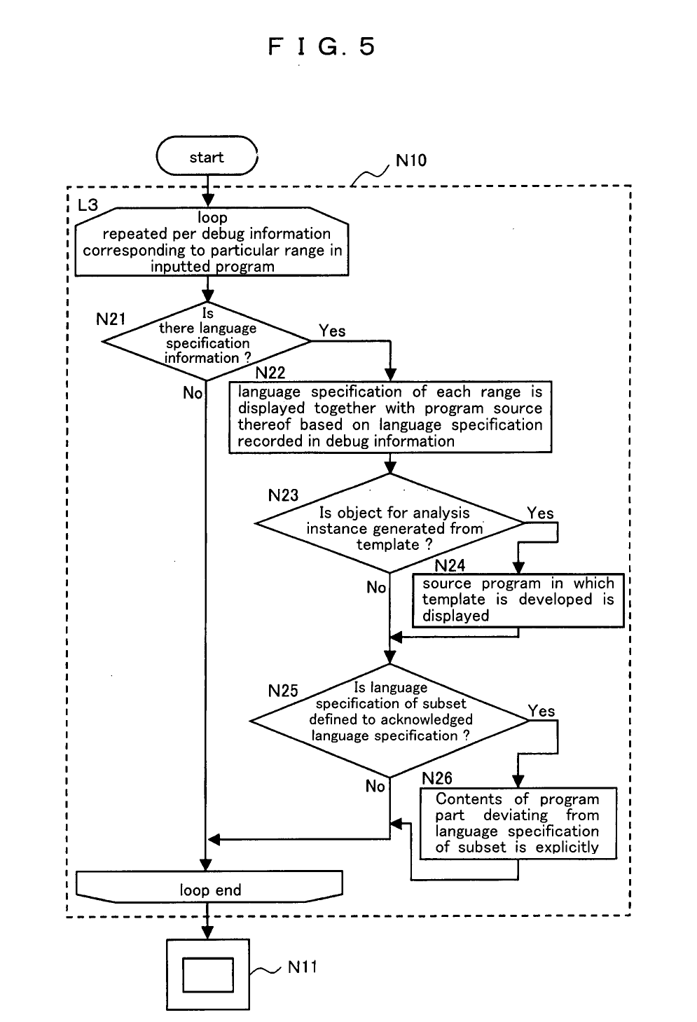

Hereinafter, the partial language specification displaying step N10, that is a key structure of the present invention, is described. FIG. 5 is a flow chart showing details of the partial language specification displaying step N10. In a loop processing L3, Steps N21-N26 are executed by each of the debug information corresponding to the particular ranges of the inputted program. The processing advances to the Step N21 in the presence of the object for analysis, while advancing to the Step N11 in the absence of the object for analysis.

In the Step N21, it is judged if there is the language specification information. The processing advances to the Step N22 when a result of the judgment is true, while advancing to the loop processing L3 when the judgment is not true. In the Step N22, the language specification of each range is displayed together with its program source based on the language specification information recorded in the debug information, and the processing advances to the Step N23.

In the Step N23, it is judged if the object for analysis is an instance generated from the template. The processing advances to the Step N24 when a result of the judgment is true, while advancing to the Step N25 when the result is not true. In the Step N24, the source program in which the template is developed is displayed, and the processing advances to the Step N25.

In the Step N25, it is judged if the language specification of the subset is defined to the acknowledged language specification. The processing advances to the Step N26 when a result of the judgment is true, while advancing to the loop processing L3 when the result is not true. In the Step N26, contents of a part of the program deviating from the language specification of the subset are clearly described.

When the debugging process including the partial language specification displaying step N10 described above is executed, the programmer can easily grasp with which language specification each part of the program is compiled and which part of the source program should be corrected when it is changed to the language specification of the subset. As a result, the debugging and tuning operations can be efficiently executed.

Hereinafter, the compile method and the debug method according to the present invention are described in more detail referring to a specific example in which the C++ language is used as the language specification of the superset and the C language is used as the language specification of the subset.

### SPECIFIC EXAMPLE 1

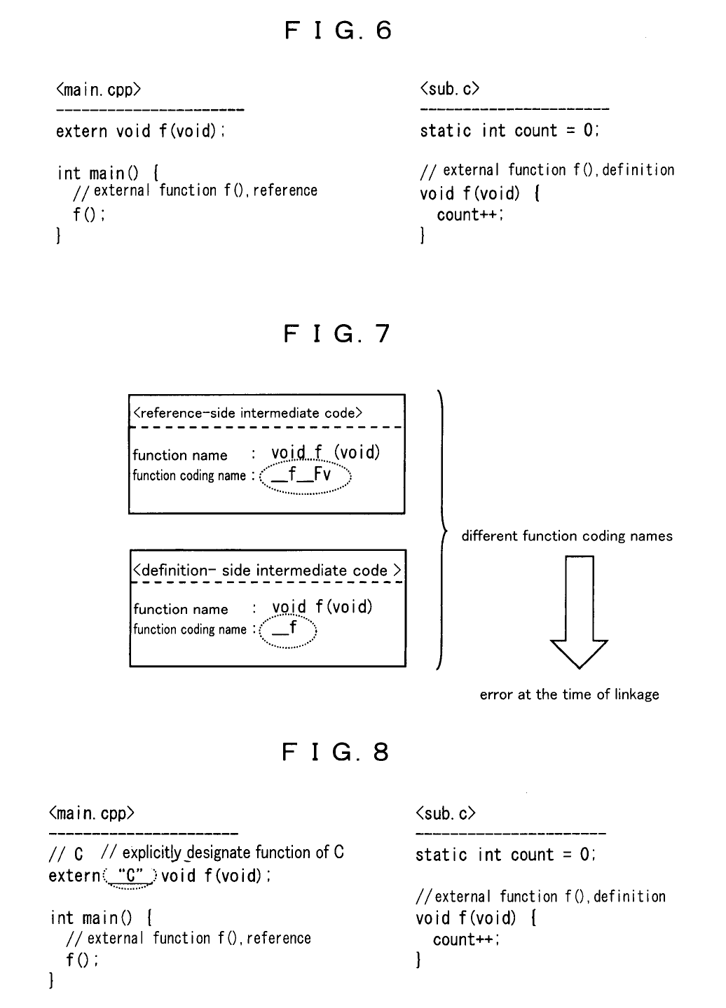

FIG. 6 shows an example of the source program memorized in the program memorizing unit D1. A description is given below of the compile method in the case where the source program is inputted. It is assumed that a user designates that <main. cpp> is compiled as the C++ language and <sub.c> is compiled as the C language. The language specification can be designated in such a manner that #pragma is described in the source program, which is, however, similar to the case where the language specification is designated based on a command line, so it is omitted in this description. The source file, <main. cpp>, shown in FIG. 6 refers to the external function f. The source file, <sub. c>, defines the external function f.

Referring to FIG. 7, a problem to be solved is mentioned in advance. FIG. 7 shows a part of information in the intermediate codes respectively on the reference side and the definition side of the function f that are generated in the intermediate code generating step S3.

In the case of compiling the specific example 1 according to the conventional method, linkage is carried out without taking the language specification of the intermediate code of the object for analysis into account. Therefore, the function coding names are different in the specific example 1 (_f_Fv and _f), which results in generation of an error at the time of the linkage. Therefore, as shown in FIG. 8, it is necessary, to consolidate the function coding name in such a manner that the user corrects the program so that a linkage assignment is explicitly shown (see “C”). Thus, the correcting step is conventionally necessary to use the source in the C language also in the C++ language, which deteriorates a degree of efficiency in the development process.

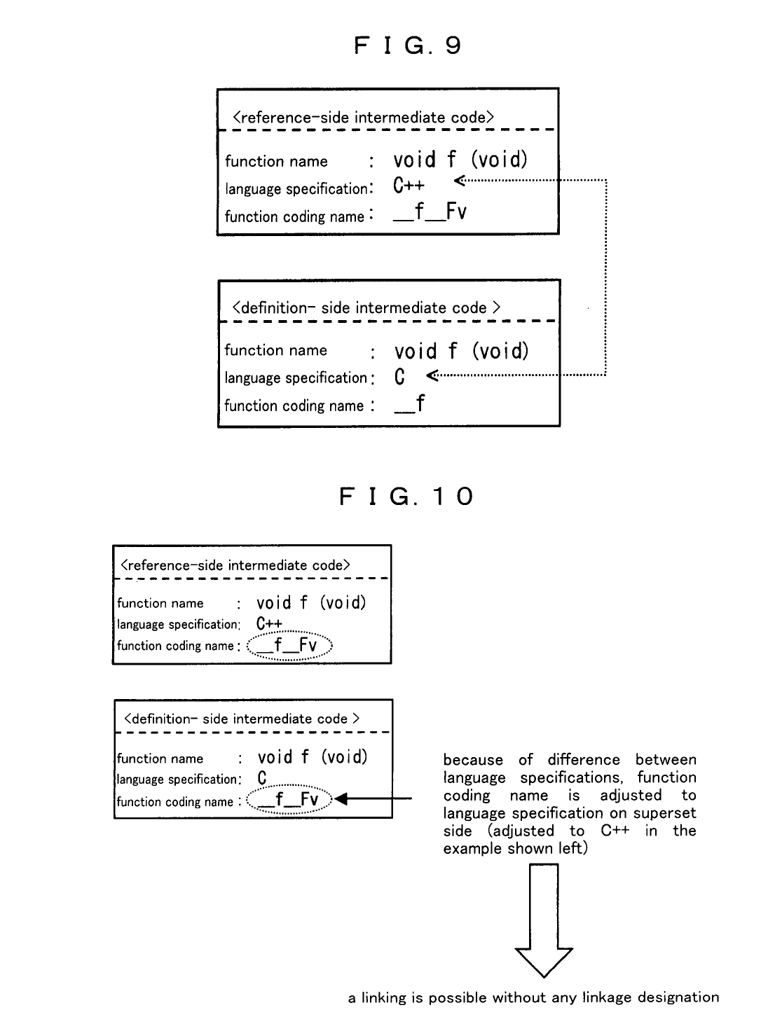

Next, a specific example of the present preferred embodiment is shown. In the present specific example, analysis is performed in a range of a function scope. In the partial language specification deciding step S10, the loop processing L1 shown in FIG. 2 (Steps S21-S25) is executed by each of the intermediate codes that correspond to a range of the respective function scopes with respect to the intermediate codes generated in the intermediate code generating step. In the present specific example, it is assumed that the user designates that <main. cpp> is compiled with the C++ language, and <sub.c> is compiled with the C language. Therefore, the judgment result of the Step S24 is true, and the Step S25 is executed. As a result, the information indicating that the language specification is the C++ language is recorded in the intermediate code on the reference side, while the information indicating that the language specification is the C language is recorded in the intermediate code on the definition side (see FIG. 9).

Next, the partial code correcting step S11 is executed. First, the loop processing L2 (Steps S31-S38) shown in FIG. 3 is executed. In the present specific example, there is a difference between the language specification, information of the intermediate codes respectively on the definition side and the reference side (C++ language and C language). Therefore, the judgment result of the Step S31 is true, and the Step S32 is executed. Comparing the C++ language and the C language to each other, the C++ language is the language specification of the superset, while the C language is the language specification of the subset. Therefore, the function coding name of the intermediate code on the definition side having the language specification of the subset is changed into the function coding name of the intermediate code on the reference side having the language specification of the superset (FIG. 10, consolidate to _f_Fv). In the Steps S33-S38 thereafter, it is judged that all of the steps are not true.

As described above, by considering the language specification of the intermediate code of the object for analysis so that the same function coding name is consolidated, and it is allowed to link without the explicit assignment of the linkage. Therefore, the step of correcting the source, which was conventionally necessary to use the source in the C language also as the one in the C++ language, becomes unnecessary. As a result, the development process can achieve an improved efficiency.

### SPECIFIC EXAMPLE 2

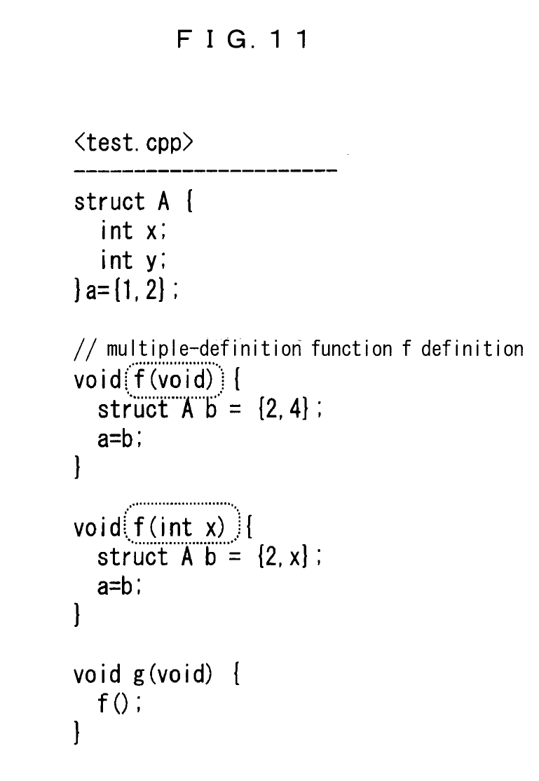

FIG. 11 shows an example of a source program using a multiple-definition function memorized in the program memorizing unit D1. The source program in which the namespace and the template are used is processed in a manner similar to the specific example in the case of the multiple-definition function, the description of which is omitted. A description is given below of the compile method in the case where the relevant source program is inputted. It is assumed that <test.cpp> is compiled without the designation of the language specification from the user.

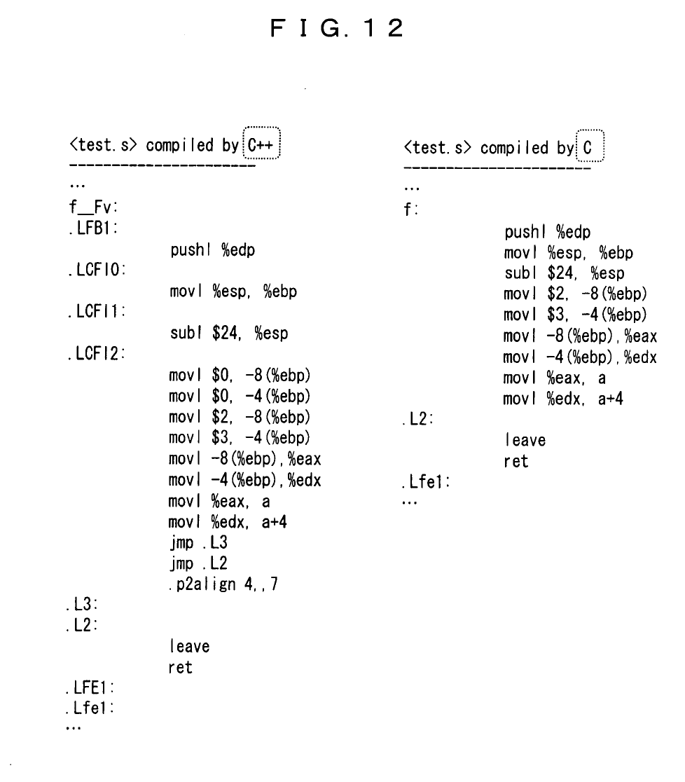

Referring to FIG. 12, problem area is pointed out in advance. In the case of compiling the source program <test. cpp> in the present specific example according to the conventional method, all of the functions are compiled as the functions of the C++ language because the multiple-definition function, which is the facility of the C++ language, is used in the source program. Because the functions are compiled as the functions of the C++ language even though only the facility of the C language is used in the bodies of the functions, the code may be redundantly generated. FIG. 12 shows a code generating result in the case where “void f (void) of “test.cpp” is compiled as the function of the C++ language and a code generating result in the case where it is compiled as the function of the C language. As it is clear from FIG. 12, the code is redundantly generated in the code generating result compiled as the function of the C++ language in comparison to the one compiled as the function of the C language.

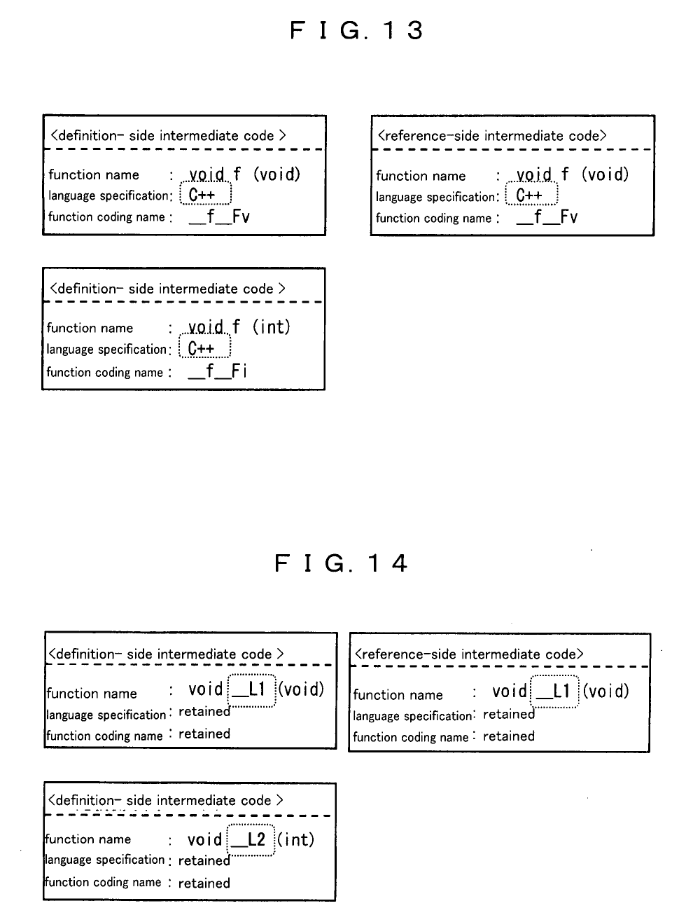

Next, another specific example of the present preferred embodiment is shown. In a manner similar to the specific example 1, analysis is executed to the function scope in the present specific example. In the partial language specification deciding step S10, the loop processing L1 shown in FIG. 2 (Steps S21-S25) is executed by each of the intermediate codes that correspond to the respective function scopes with respect to the intermediate codes generated in the intermediate code generating step. In the present specific example, since the language specification is not designated through the user, the judgment results of the Steps S22 and S24 are both not true, and the Steps S23 and S25 are not executed. Therefore, the language specification information decided based on the facility of the programming language used in the range of the object for analysis is recorded in the intermediate code (Step S21). In the present specific example, the functions, “void f(void)” and “void f(int)” are the multiple-definition functions having the same function name, and are the facilities (functions) of the C++ language. Therefore, the information that the language specification is the C++ language is recorded in the intermediate codes in the range in which these facilities are used (C++ language in all of the intermediate codes shown in FIG. 13).

Next, the partial code correcting step S11 is executed. First, the loop processing L2 shown in FIG. 3 (Steps S31-S38) is executed. In the present specific example, since there is no difference between the language specification information of the intermediate code on the definition side and the language specification information of the intermediate code on the reference side (both in the C+language), the Step S32 is not executed, while the Step S34 is executed because the relevant function is the multiple-definition function. In the present specific example, as shown in FIG. 14, the function name is changed into such function names as _ _L1, _ _L2, that are external function names having singular function names and are not multiple-defined in the program, and thereafter each of the language specifications and the function coding names are retained. The multiple-definition function is recited as an example in the present specific example, however, the function name may be changed into an external function having a singular function name and is not multiple-defined in the program in the program in which the namespace and the template are used in a manner similar to the multiple-definition function (Steps S36 and S38).

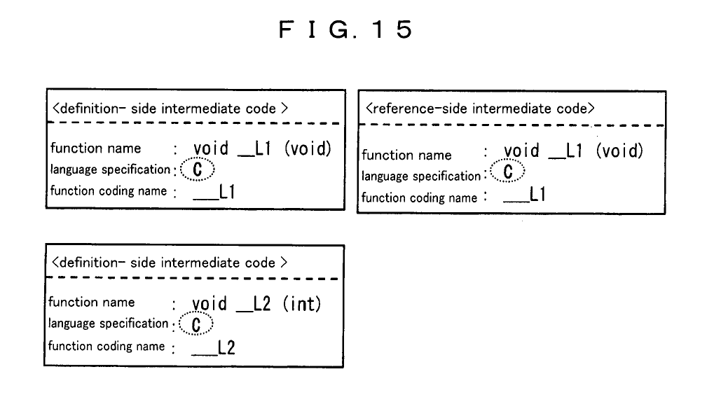

As a result that the Step S34 is executed, the judgment result of the Step S39 is true, and the partial language specification deciding Step S10 is executed again. At the second execution of the Step S10, since the function names of the multiple-definition functions are changed into _ _L1, _ _L2. Therefore, the relevant functions are not acknowledged as the multiple-definition functions. Then, the information indicating that the language specification is the C language is recorded in the Step S21, and the function coding names as the C language are given to the relevant functions (FIG. 15). no particular change is made in the execution of the second Step S1, and the processing advances to the processing steps on and after the Step S12.

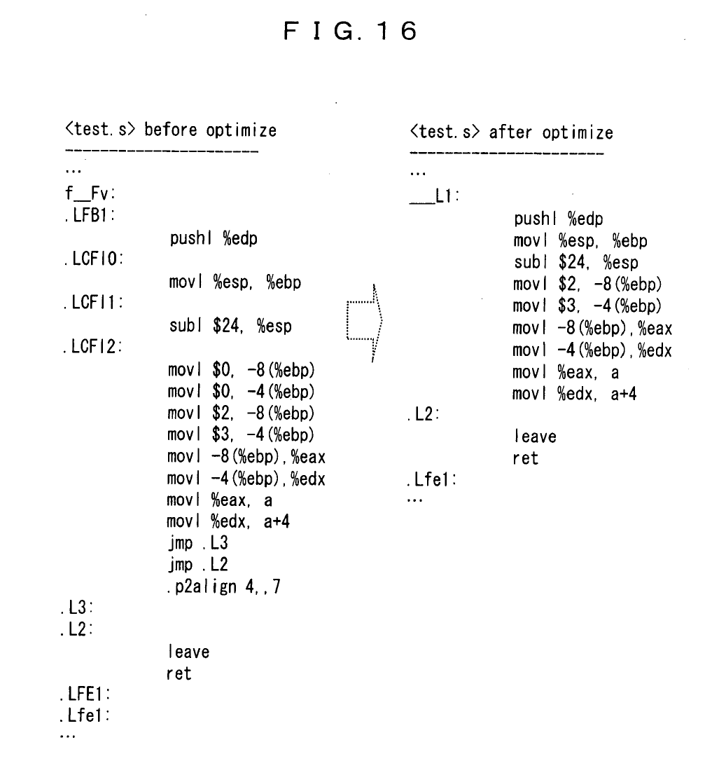

FIG. 16 shows a code generating result in the case where the present invention is not applied to the present specific example and a code generating result in the case where the present invention is applied thereto. As clear from FIG. 16, any redundant code is deleted in the case where the present invention is applied in comparison to the case where the present invention is not applied.

### SPECIFIC EXAMPLE 3

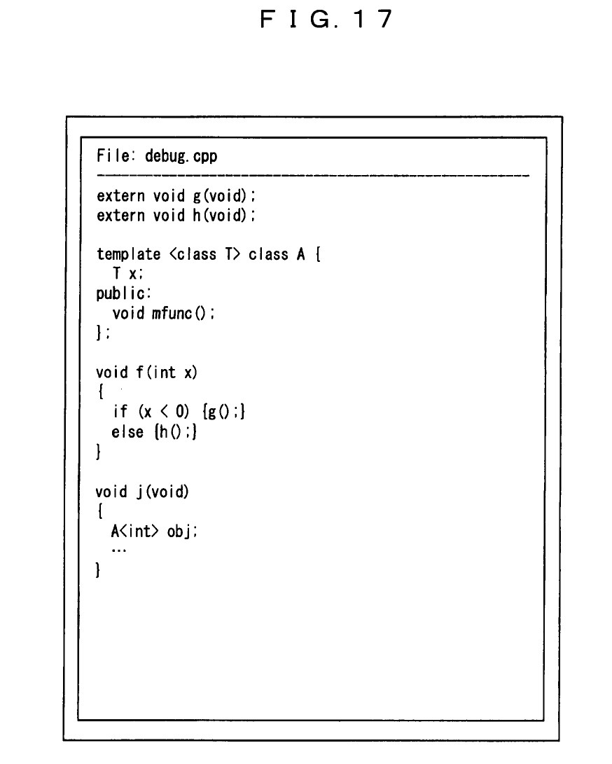

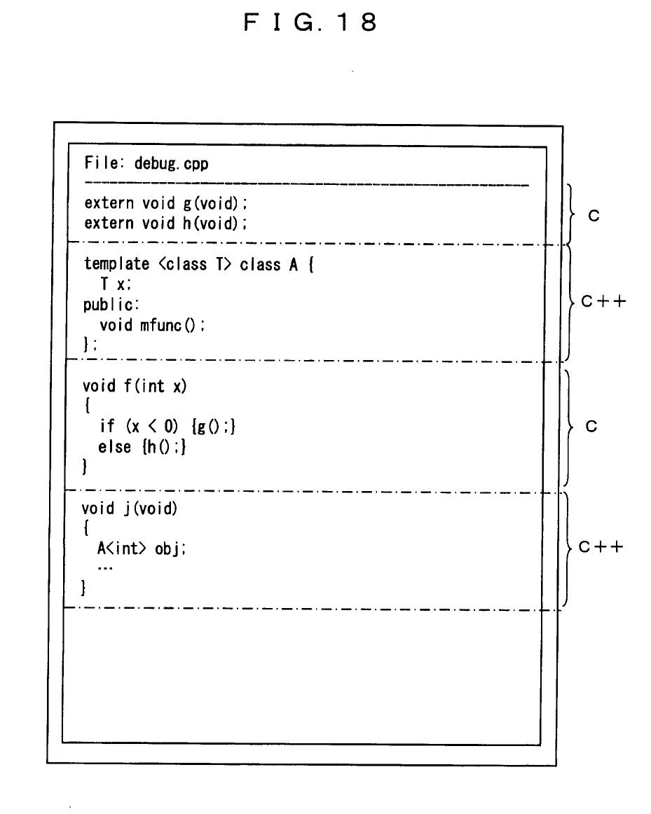

A specific example of the debug method is shown. It is assumed in the present specific example that the language specification information recorded in the intermediate code according to the compile method of the present invention is also recorded in debug information. FIG. 17 shows a monitor that executes a debug program. When the partial language specification display command is inputted, the partial language specification displaying step N1 is executed. In the present specific example, the Step N22 is executed because it is assumed that the language specification information is recorded in the debug information, and the language specifications in each of at least two ranges set in the inputted program are displayed together with their program sources based on the language specification information recorded in the debug information. FIG. 18 shows an example of the language specification display. The display example merely shows an example, and any manner is acceptable as far as the information concerning the language specification is displayed.

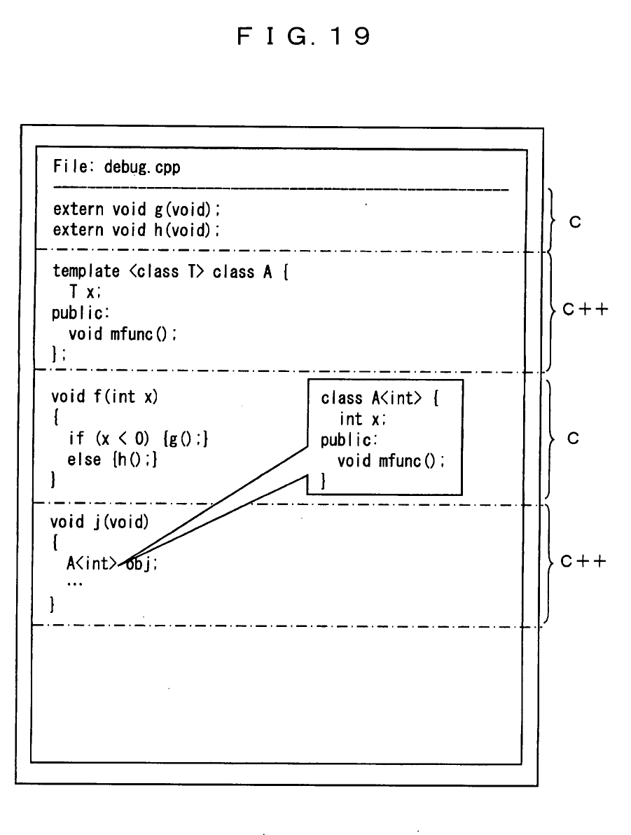

Next, it is judged where or not the object for analysis is an instance generated from the template (Step N23). In the present specific example, in the case where the object for analysis is A<int>obj, a result of the judgment is true because the instance is generated from the template, and the source program where the template is developed is displayed as shown in FIG. 19. The display example merely shows an example, and any manner is acceptable as far as the information concerning the source program where the template is developed is displayed.

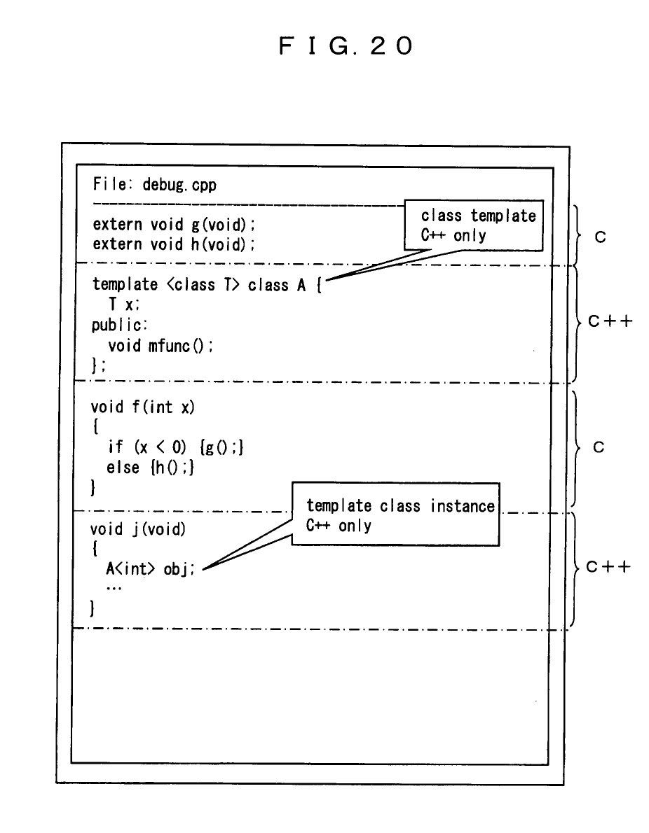

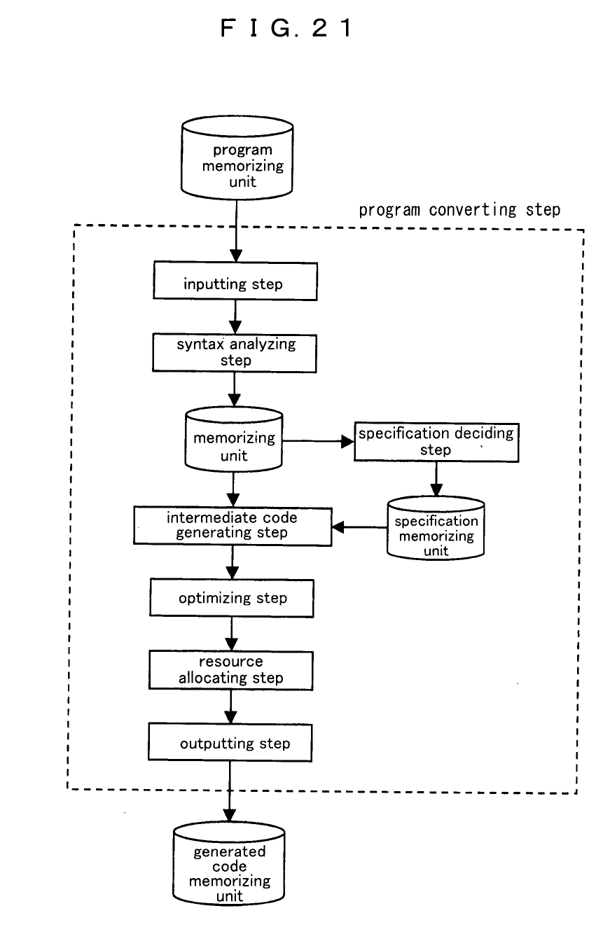

Next, it is judged whether or not the language specification of the subset is defined to the acknowledged specification (Step N25). In the present specific example, since the C language, that is the subset specification of the C++ language, is defined, a result of the judgment is true. Then, as shown in FIG. 20, contents of a part deviating from the language specification of the C language (template facility) in the range where the language specification is judged to be the C++ language, are explicitly described. The display example merely shows an example, and any manner is acceptable as far as the information concerning the contents of the part deviating from the language specification of the subset is displayed.

As is clear from FIGS. 18-20, when the debug method according to the present invention is used, the programmer can easily grasp which part of the program is compiled based on which language specification and which part of the source program should be corrected when it is changed into the language specification of the subset. As a result, the debugging and tuning operation can be efficiently executed.

While preferred embodiments of this invention has been described in detail, it will be understood that various modifications may be made therein, and it is intended to cover in the appended claims all such modifications as fall within the true spirit and scope of this invention.

What is claimed is:

1. A compile method for converting an inputted program into an object program, including:
a partial language specification deciding step for deciding language specification in each of at least two particular ranges set in the inputted program;
a judging step for judging if there is a difference between the language specifications in the particular ranges; and
a partial code correcting step for correcting at least a part of codes in one of the particular ranges when it is judged that there is the difference between the language specifications in the particular ranges.

2. The compile method as claimed in claim 1, wherein
the language specifications are decided based on facility of a programming language used in the particular ranges in the partial language specification deciding step.

3. The compile method as claimed in claim 1, wherein
the language specifications are decided based on a language specification control statement in the case where the language specification control statement is present in the inputted program in the partial language specification deciding step.

4. The compile method as claimed in claim 1, wherein
the language specifications are decided based on a language specification control instruction in the case where the language specification control instruction is provided to a compile system for compiling the inputted program in the partial language specification deciding step.

5. The compile method as claimed in claim 1, wherein
a function coding name having a language specification of a subset is changed into a function coding name having a language specification of a superset in the case where there is a difference between the language specifications of definition and reference in all of functions in the partial code correcting step.

6. The compile method as claimed in claim 1, wherein
in the partial code correcting step, all of external functions that are multiple-defined are changed into an external function that has a singular function name and is not multiple-defined in the program, and the partial language specification deciding step is executed again when the all of external functions that are multiple-defined are changed into the external function which has the singular function name and is not multiple-defined in the program.

7. The compile method as claimed in claim 1, wherein
in the partial code correcting step, all of external functions which belong to a namespace into an external function which has a singular function name and does not belong to the namespace in the program, and the partial language specification deciding step is executed again when the all of external functions which belong to the namespace are changed into the external function which has the singular function name and does not belong to the namespace in the program.

8. The compile method as claimed in claim 1, wherein
in the partial code correcting step, all of external functions which are generated from a template are changed into an external function which has a singular function name and is not generated from the template in the program, and the partial language specification deciding step is executed again when the all of external functions which are generated from the template are changed into the external function which has the singular function name and is not generated from the template in the program.

9. A debug method for debugging an inputted program, including:
a partial language specification acknowledging step for acknowledging language specifications in each of at least two particular ranges set in the inputted program; and
a partial language specification displaying step for displaying the acknowledged language specifications in each of the particular ranges together with program source thereof.

10. The debug method as claimed in claim 9, further including a template development displaying step for displaying a source program where the template is developed in the case where an object for analysis is an instance generated from the template.

11. The debug method as claimed in claim 9, further including a step for displaying violation part to a subset language specification where contents of a part of the program deviating from a language specification of a subset is explicitly shown in the case where the language specification of the subset is defined in the acknowledged language specification.

12. A compile program for converting an inputted program into an object program, the compile program making a computer execute:
a partial language specification deciding facility for deciding language specification in each of at least two particular ranges set in the inputted program;
a facility for judging if there is a difference between the language specifications in the particular ranges; and
a partial code correcting facility for correcting at least a part of codes in one of the particular ranges in the case where it is judged there is difference between the particular ranges.

13. The compile program as claimed in claim 12, wherein
the partial language specification deciding facility decides the language specification based on facility of a programming language used in the particular ranges.

14. The compile program as claimed in claim 12, wherein
the partial language specification deciding facility decides the language specifications based on a language specification control statement in the case where there is the language specification control statement in the inputted program.

15. The compile program as claimed in claim 12, wherein
the partial language specification deciding facility decides the language specifications based on a language specification control instruction in the case where the language specification control instruction is provided to a compile system for compiling the inputted program.

16. The compile program as claimed in claim 12, wherein
the partial code correcting facility changes a function coding name having a language specification of a subset into a function coding name having a language specification of a superset in the case where there is a difference between the language specifications of definition and reference in all of functions.

17. The compile program as claimed in claim 12, wherein
the partial code correcting facility changes all of external functions which are multiple-defined into an external function which has a singular function name and is not multiple-defined in the program, and the partial language specification deciding facility is executed again when the all of external functions which are multiple-defined are changed into the external function which has the singular function name and is not multiple-defined in the program.

18. The compile program as claimed in claim 12, wherein
the partial code correcting facility changes all of external functions which belong to a namespace into an external function which has a singular function name and does not belong to the namespace in the program, and the partial language specification deciding function is executed again when the all of external functions which belong to the namespace are changed into the external function which has the singular function name and does not belong to the namespace in the program.

19. The compile program as claimed in claim 12, wherein
the partial code correcting facility changes all of external functions which are generated from a template into an external function which has a singular function name and is not generated from the template in the program, and the partial language specification deciding step is executed again when the all of external functions which are generated from the template are changed into the external function which has the singular function name and is not generated from the template in the program.

20. A debug program for debugging an inputted program, the debug program making a computer execute:
a partial language specification acknowledging facility for acknowledging language specifications in each of at least two particular ranges set in the inputted program; and
a partial language specification displaying facility for displaying the acknowledged language specifications in each of the particular ranges together with program source thereof.

21. The debug program as claimed in claim 20, wherein
the program further makes the computer execute a template development displaying facility for displaying a source program in which the template is developed in the case where an object for analysis is an instance generated from the template.

22. The debug program as claimed in claim 20, wherein
the program further makes the computer execute a subset language specification violation displaying step for explicitly showing contents of a part of the program deviating from a language specification of a subset in the case where the language specification of the subset is defined in the acknowledged language specification.
